(19) United States
(12) Patent Application Publication
(10) Pub. No.: US 2008/0235593 A1
(43) Pub. Date: Sep. 25, 2008

(54) Mobile device system and mobile device

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,245

(22) Filed: Sep. 20, 2007

(30) Foreign Application Priority Data
Sep. 28, 2006 (JP) 2006-264753

(51) Int. Cl. G06F 3/00

(52) U.S. Cl. 715/733

(57) ABSTRACT

When one mobile device is activated, the existence of information which other mobile devices hold is also confirmed. There is provided a mobile device system including a plurality of mobile devices, wherein each mobile device includes a communication unit for communicating with other mobile devices, an information storage unit for storing information, a list storage unit for storing a list of information stored in the information storage unit and in the information storage units of the other mobile devices, a display unit, and a control unit. The control unit displays the list stored in the information storage unit on the display unit and, when information stored in the information storage unit of another mobile device is specified, requests transmission of information from the other mobile device using the communication unit and displays information transmitted in response to the request on the display unit.

### BACKGROUND OF THE INVENTION

1. Field of the Invention

The present invention relates to a mobile device system in which a plurality of mobile devices operate in cooperation with each other.

This application is based on Japanese Patent Application No. 2006-264753, the content of which is incorporated herein by reference.

2. Description of Related Art

Recently, due to the diversification of information, when people go out, in many cases they carry multiple mobile devices having various functions, such as mobile phones, laptop computers, information communication terminals, digital cameras, and music players (see Japanese Unexamined Patent Application, Publication No. 2002-9879).

For example, Japanese Unexamined Patent Application, Publication No. 2002-9879 discloses use of multiple mobile devices in combination by sending image data captured with a digital camera to a mobile phone via a local network and then further sending it onto an external network using the mobile phone.

### BRIEF SUMMARY OF THE INVENTION

A first aspect is a mobile device system including a plurality of mobile devices, wherein each mobile device includes a communication unit for communicating with other mobile devices, an information storage unit for storing information, a list storage unit for storing a list of information stored in the information storage unit and in the information storage units of the other mobile devices, a display unit, and a control unit, wherein the control unit displays the list stored in the information storage unit on the display unit and, when information stored in the information storage unit of another mobile device is specified, requests transmission of information from the other mobile device using the communication unit and displays information transmitted in response to the request on the display unit.

A second aspect is a mobile device including a communication unit for communicating with other mobile devices; an information storage unit for storing information; a list storage unit for storing a list of information stored in the information storage unit and in the information storage units of the other mobile devices; a display unit; and a control unit, wherein the control unit displays the list stored in the information storage unit on the display unit and, when information stored in the information storage unit of another mobile device is specified, requests transmission of the information from the other mobile device using the communication unit and displays information transmitted in response to that request on the display unit.

### BRIEF DESCRIPTION OF THE SEVERAL VIEWS OF THE DRAWINGS

FIG. 1 is a diagram showing the configuration of a mobile device system.

FIG. 2 is a diagram showing common components provided in each mobile device in the mobile device system.

FIG. 3 is a diagram showing an example of a list stored in a list storage unit.

FIG. 4 is a flowchart showing the procedure of a process executed by a control unit.

FIG. 5 is a diagram showing an example of a display screen.

FIG. 6 is a diagram showing the display screen when Pictures is selected on the display screen shown in FIG. 5.

FIG. 7 is a diagram showing the display screen transition when Pictures is selected on the display screen shown in FIG. 5.

FIG. 8 is a diagram showing the display screen when a mobile phone is selected on the display screen shown in FIG. 7.

FIG. 9 is a diagram showing the display screen transition when the mobile phone is selected on the display screen shown in FIG. 7.

FIG. 10 is a timing chart showing the procedure of a list-updating process executed by the control unit.

FIG. 11 is a diagram showing an example of the display screen according to a first modification.

FIG. 12 is a diagram showing an example of the display screen when a mobile phone is selected on the display screen shown in FIG. 11.

FIG. 13 is a diagram showing the display screen transition when the mobile phone is selected on the display screen shown in FIG. 11.

FIG. 14 is a diagram showing the display screen transition when the mobile phone is selected on the display screen shown in FIG. 11.

FIG. 15 is a diagram showing an example of the display screen according to a second modification.

FIG. 16 is a diagram showing the display screen when Pictures is selected on the display screen shown in FIG. 15.

FIG. 17 is a diagram showing the display screen transition when Pictures is selected on the display screen shown in FIG. 15.

FIG. 18 is a diagram showing an example of the display screen according to a third modification.

### DETAILED DESCRIPTION OF THE INVENTION

A mobile device system of the present invention includes a plurality of mobile devices, wherein each mobile device includes a communication unit for communicating with other mobile devices, an information storage unit for storing information, a list storage unit for storing a list of information stored in the information storage unit and in the information storage units of the other mobile devices, a display unit, and a control unit, wherein the control unit displays the list stored in the information storage unit on the display unit and, when information stored in the information storage unit of another mobile device is specified, requests transmission of information from the other mobile device using the communication unit and displays information transmitted in response to the request on the display unit.

With this configuration, because the list stored in the list storage unit is displayed on the display unit, the user can confirm the existence of information held in the other mobile devices by checking this display unit. Thus, operations such as activating another mobile device then confirming the existence of the information are not required.

Also, when information stored in the information storage unit of another mobile device is specified on the list displayed on the display unit of the mobile device, a transmission request for that information is sent to the other mobile device. In such a case, if the other mobile device receiving this request is in the activated mode, the information is sent back and displayed on the display unit of the first mobile device. Therefore, the user can check that information as if it were stored in the information storage unit of the mobile device that he or she is operating.

In the mobile device system described above, the control unit of each mobile device may obtain file types from the list storage unit and may display a list of the obtained file types on the display unit.

With this configuration, because a list of file types of each kind of file information stored in the information storage devices of the mobile device and the other mobile devices is displayed on the display unit, the user can select the desired file type from the list without being aware of which mobile device's information storage unit the desired file information is stored in. Also, when one file type is selected on the display screen by the user, the control unit reads the file information corresponding to the selected file type from the list storage unit and displays it on the display unit. Thus, by performing display in stages, the user can easily specify the desired file information.

In the mobile device system described above, each of the control units may extract file types and file information from the list storage unit and may display the extracted file types and a list of each file information corresponding thereto on the display unit.

According to this configuration, each item of file information stored in the information storage units of the mobile device and the other mobile devices is separated by file type and displayed on the display unit. Thus, the user can specify the desired file information from the display screen without being aware of which mobile device's information storage unit the desired file information is stored in. As a result, the user can efficiently specify the desired file information.

In the mobile device system described above, each of the mobile devices may include an activating unit for activating power in response to an activation signal from another mobile device, and when the information specified on the list is stored in the information storage unit of another mobile devices, the control unit of each mobile device may control the communication unit so as to send an activation signal to that other mobile device.

With this configuration, because the other mobile device is activated remotely, the information stored in the information storage unit of that other mobile device can be obtained. Thus, it is possible to reliably display the information specified by the user.

In the mobile device system described above, each mobile device may include a list updating unit for updating the list stored in the list storage unit when the information stored in the information storage unit is changed, or when update information is received from another mobile device, and the control unit of each mobile device may control the communication unit so as to send update information to the other mobile devices when the information stored in the information storage unit of that mobile device is changed.

According to this configuration, when the information stored in the information storage unit of one mobile device changes, that update information is sent to the other mobile devices by the communication unit of that one mobile device, and in the other mobile devices receiving this update information, the lists stored in the list storage units are updated by the list-updating units on the basis of this update information. Accordingly, the most recent list information can be shared among the mobile devices.

A mobile device of the present invention includes a communication unit for communicating with other mobile devices; an information storage unit for storing information; a list storage unit for storing a list of information stored in the information storage unit and in the information storage units of the other mobile devices; a display unit; and a control unit, wherein the control unit displays the list stored in the information storage unit on the display unit and, when information stored in the information storage unit of another mobile device is specified, requests transmission of the information from the other mobile device using the communication unit and displays information transmitted in response to that request on the display unit.

With this configuration, because the list stored in the list storage unit is displayed on the display unit, the user can confirm the existence of information held in the other mobile devices by checking this display unit. Thus, operations such as activating another mobile device then confirming the existence of the information are not required.

Also, when information stored in the information storage unit of another mobile device is specified on the list displayed on the display unit of the mobile device in question, a transmission request for that information is sent to the other mobile device. In such a case, if the other mobile device receiving this request is in the activated mode, the information is sent back and displayed on the display unit of the mobile device. Therefore, the user can check that information as if it were stored in the information storage unit of the mobile device that he or she is operating.

The various aspects described above can be used in combination within the permissible scope of the invention.

The mobile device or mobile device system described above affords an advantage in that it is also possible to confirm the existence of information held in other mobile devices when one mobile is activated.

An embodiment of a mobile device system will be described below with reference to the drawings.

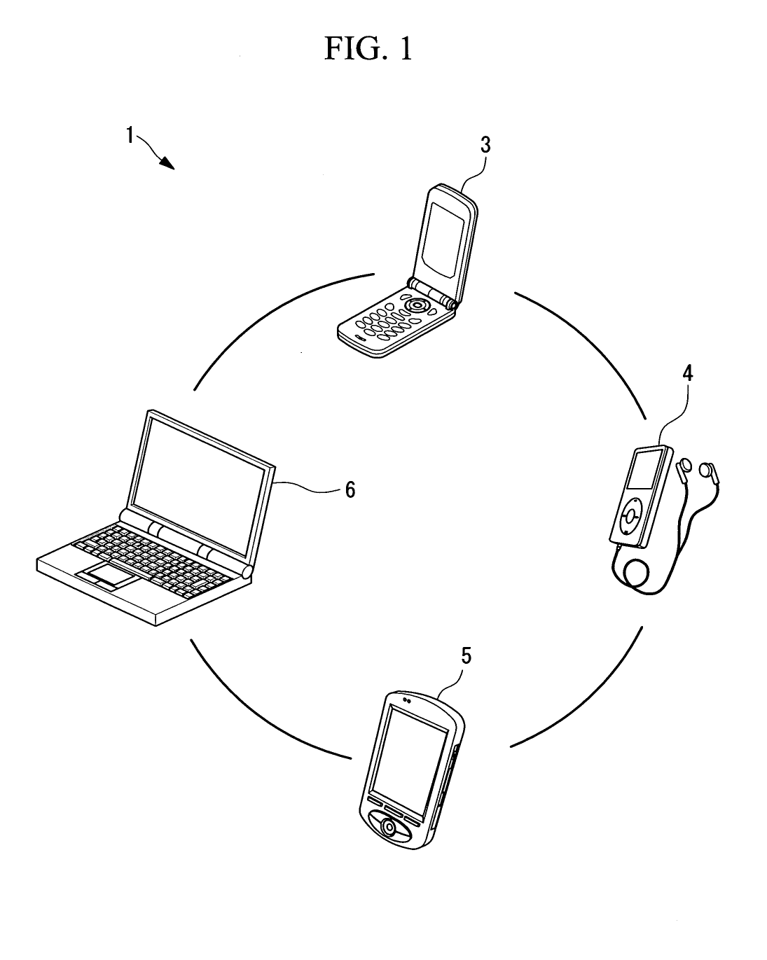

FIG. 1 illustrates an example configuration of a mobile device system 1. As shown in the drawing, the mobile device system 1 includes a plurality of mobile devices, more specifically, a mobile phone 3, a portable music player 4, a PDA (personal digital assistant) 5, and a laptop computer (hereinafter referred to as ‘computer’) 6. These mobile devices are only examples, and in general, any type of portable electronic device may be used in any combination.

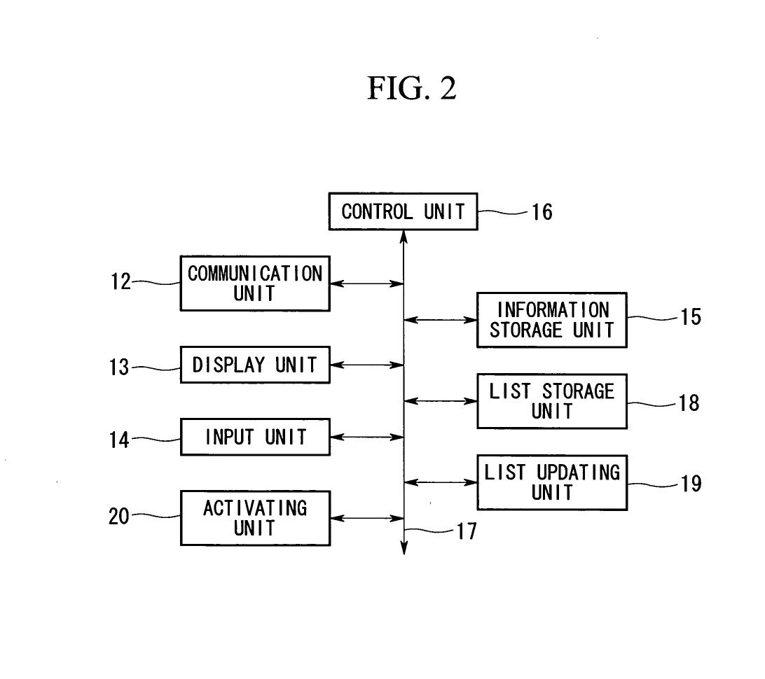

Each of the above-described mobile devices includes the following common components. Specifically, as illustrated in FIG. 2, each mobile device includes a communication unit (communication device) 12, a display unit (display device) 13, an input unit 14, an information storage unit (information storage device) 15, a control unit (control device) 16, a list storage unit (list storage device) 18, a list-updating unit (list-updating device) 19, and an activating unit (activating device) 20. These units are mutually connected via a bus 17 and are configured to be capable of sending and receiving information between each other.

The components described above may be provided separately from components that are generally included in each mobile device, or they may be used in conjunction with the components generally included in each mobile device. For example, the mobile phone 3 generally includes a communication unit, a display unit, and an input unit; therefore, of these components, the components that are duplicated are preferably used in conjunction therewith. This also applies to the other mobile devices.

The communication unit 12 is capable of communicating with other mobile devices wirelessly. For example, the communication unit 12 of the mobile phone 3 is capable of communicating with the portable music player 4, the PDA 5, and the computer 6.

The display unit 13 is, for example, a liquid crystal display. The input unit 14 is, for example, a keyboard or buttons and functions as a man-machine interface.

The information storage unit 15 holds various kinds of data such as image data and music data, and it also stores various types of information for enabling communication with other mobile devices and information to be displayed on the display unit 13, such as icons of each mobile device.

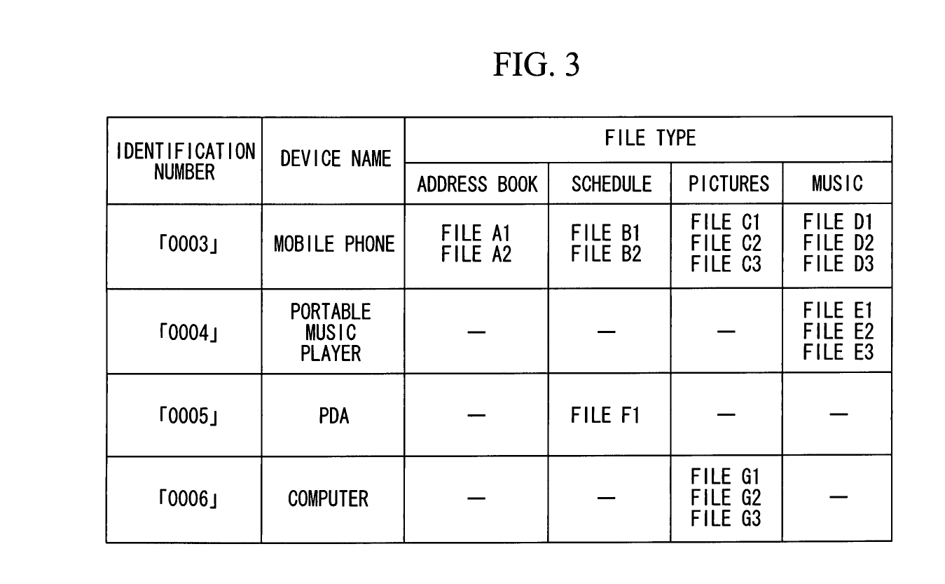

As shown in FIG. 3, a list of various kinds of data stored in the information storage unit 15 of that mobile device and lists of various kinds of data stored in the information storage units 15 of the other mobile devices are linked to identification numbers and device names of each mobile device and are stored in the list storage unit 18.

The various kinds of data in the above-described lists is categorized by file type. File type means, for example, different file formats, specifically, text data such as CSV, picture data such as JPG, and music data such as MP3. In this embodiment, address book, schedule, pictures, and music are given as examples of the file types, as shown in FIG. 3.

The list-updating unit 19 updates the lists in the list storage unit 18 when the data stored in the information storage unit 15 of that mobile device changes, and when list-update information is received from the other mobile devices, it updates the lists in the lists storage unit 18 on the basis of this update information.

The activating unit 20 activates the mobile device when an activation signal is received from another mobile device.

The control unit 16 performs overall control of each of the units described above.

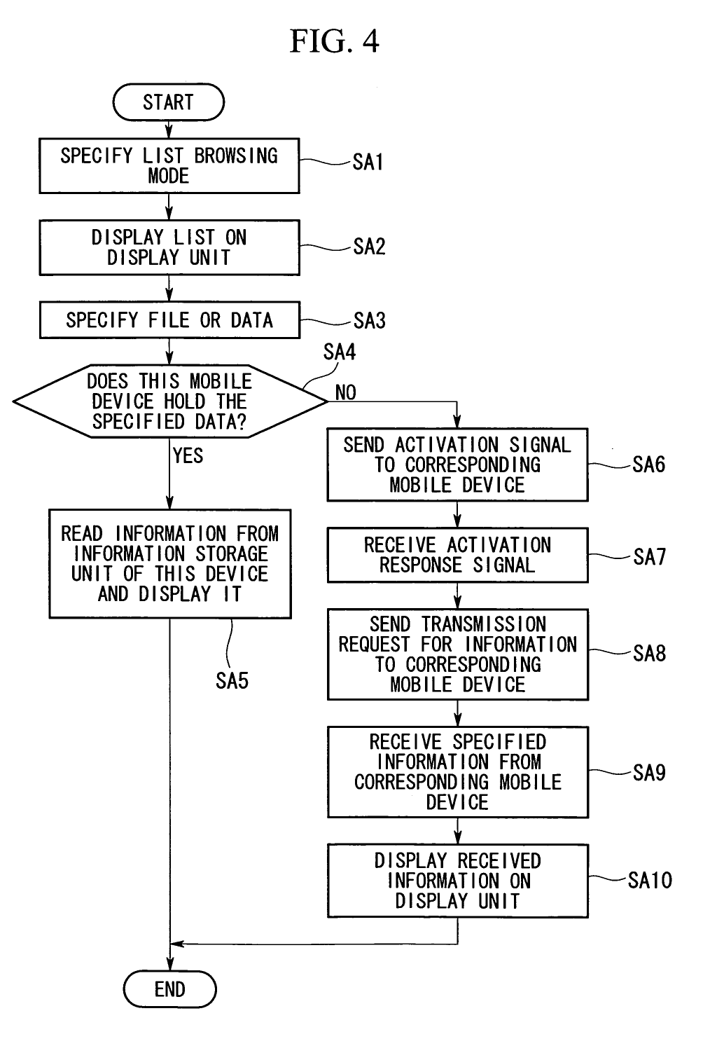

In each of the mobile devices having such a common configuration, a process shown in FIG. 4 is executed by the control unit 16. Although the process shown below is executed in the control unit 16 of each mobile device, for simplification, the control unit 16 of the mobile phone 3 will be described here as a representative example.

First, when the mobile phone 3 is operated by the user to specify a list browsing mode (step SA1 in FIG. 4), the control unit 16 of the mobile phone 3 reads the list of each mobile device from the list storage unit 18 and displays list-related information on the display unit 13 (step SA2). The user operates the input unit 14 while looking at this display screen to specify one file or item of data. For example, specifying the file or item of data is carried out as follows.

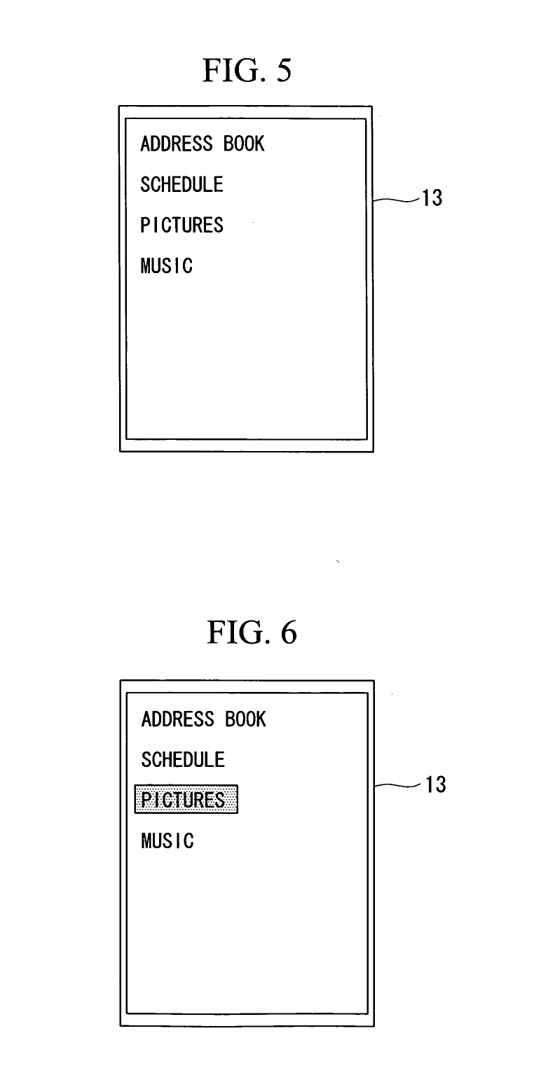

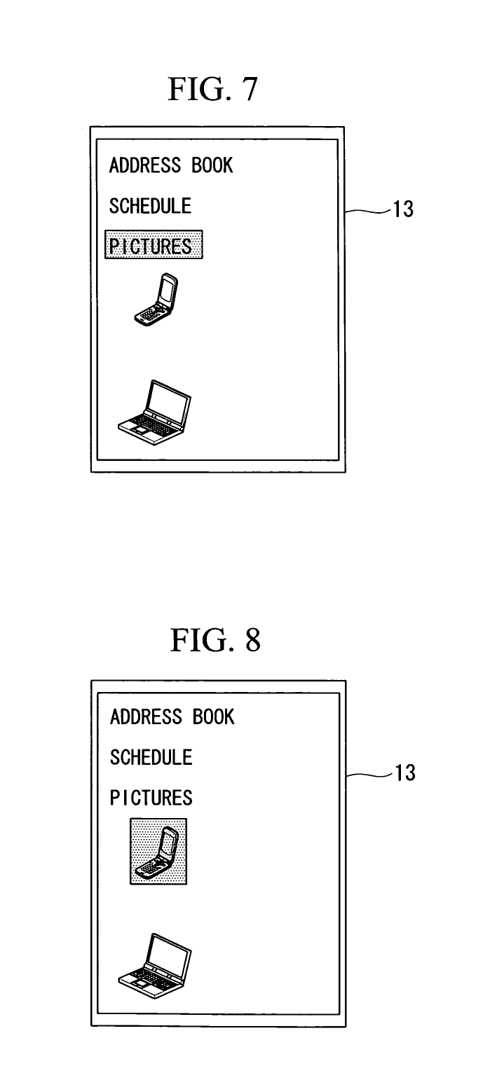

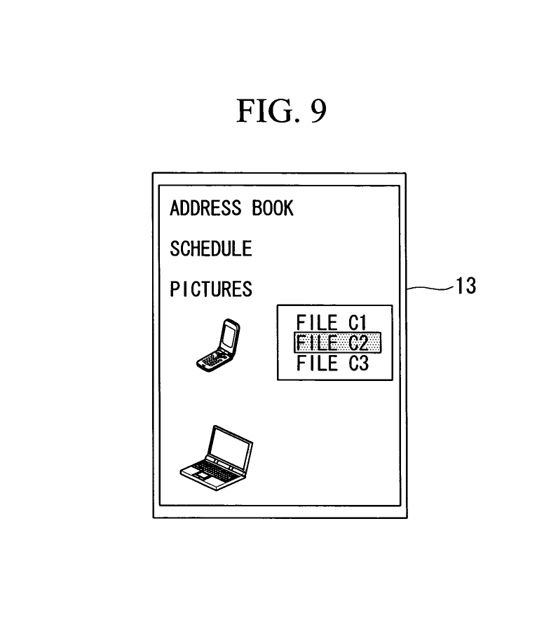

As shown in FIG. 5 for example, the control unit 16 reads file types from the list storage unit 18, and displays the read file types on the display unit 13. When one file type is specified by the user on the display screen, for example, “Pictures” as shown in FIG. 6, the control unit 16 identifies, from the list, mobile devices having picture data and displays information about the identified mobile devices on the display unit 13. Here, as shown in FIG. 3, because the mobile devices having picture data are the mobile phone 3 and the computer 6, the control unit 16 displays their icons on the display unit 13, as shown in FIG. 7. When one mobile device is specified on the display screen by the user, for example, the “mobile phone” as shown in FIG. 8, the control unit 16 identifies, from the list, picture files or data which the mobile phone 3 holds and displays the identified picture files or data of the mobile phone 3 on the display unit 13. An example of the display screen at this stage is shown in FIG. 9. The user can specify the desired file or data on this display screen. FIG. 9 shows the case where a file C2 is specified by the user.

Once a certain file or data is specified by the user (step SA3), the control unit 16 determines whether or not the specified file or data is stored in the information storage unit 15 of its mobile device (step SA4). This can be determined by referring to the list stored in the list storage unit 18.

If, as a result, the specified file or data is stored in the information storage unit 15 of the mobile device (“YES” in step SA4), the control unit 16 reads the specified data or file from the information storage unit 15 of the mobile device and displays it on the display unit 13 (step SA5). The process then ends.

On the other hand, if data stored in the information storage unit 15 of another mobile device is specified (“NO” at step SA4), an activation signal is sent to the specified other mobile device (step SA6). Accordingly, the activation signal is received by the specified other mobile devices, and the corresponding other mobile device is activated by operating the activating unit 20. The control unit 16 of this mobile device sends back an activation response signal, indicating that is has activated, to the mobile phone 3 which is the source of the activation signal.

When the activation response signal is received by the communication unit 12 in the mobile phone 3 (step SA7), the control unit 16 sends a transmission request for the file or data specified by the user to the other mobile device (step SA8). Accordingly, the other mobile device, upon receiving this transmission request, reads the specified file or data from its information storage unit 15 and sends the read file or data to the mobile phone 3 which is the source of the transmission request.

When this file or data is received by the communication unit 12 in the mobile phone 3 (step SA9), the control unit 16 displays the received file or data on the display unit 13 (step SA10). The process then ends.

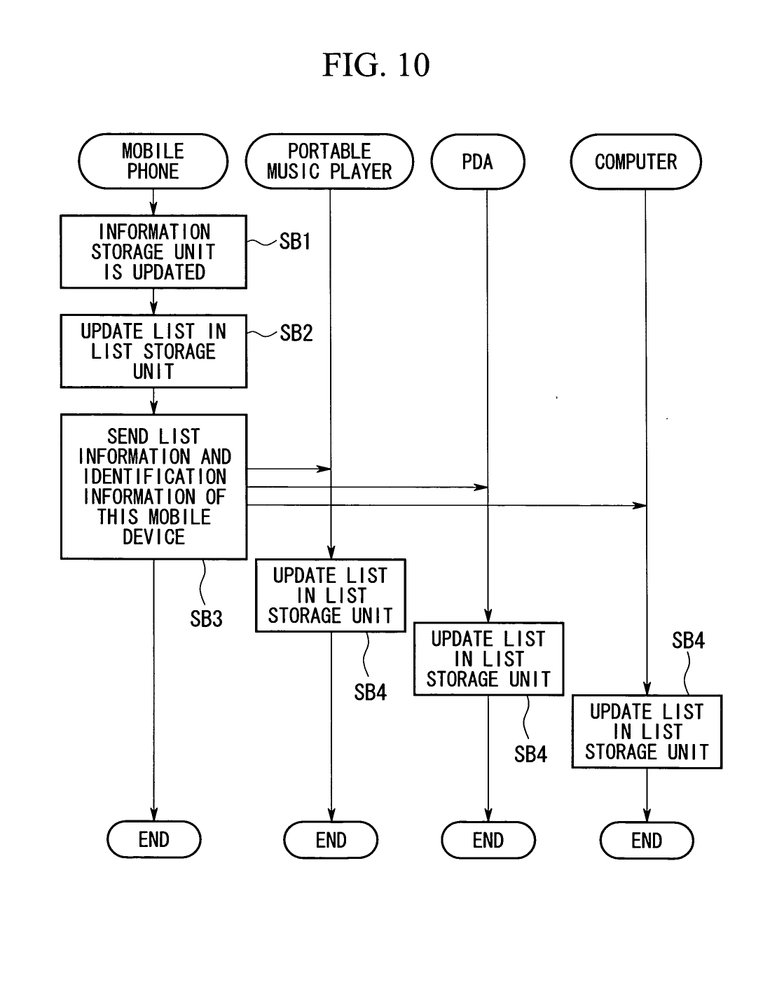

Next, the list-updating process executed in each mobile device when the information stored in the information storage unit 15 is updated will be described with reference to FIG. 10. In the following description, the case of updating the information storage unit 15 in the mobile phone 3 will be described as an example.

First, when the data in the information storage unit 15 is updated as a result of the user operating the mobile phone 3 (step SB1), the list stored in the list storage unit 18 is updated by the list-updating unit 19 according to this data update (step SB2).

For example, when a music data file X1 is added to the mobile phone 3, the list-updating unit 19 adds “File X1” to the music data list of the mobile phone 3, in the list stored in the list storage unit 18, to update the list.

When the list is updated in this way, the control unit 16 of the mobile phone 3 reads the updated list from the list storage unit 18, links this list information with identification information “0003” of that mobile device, and sends it to the other mobile devices (step SB3). Accordingly, the updated list information is received by the communication units 12 of the other mobile devices, specifically, the portable music player 4, the PDA 5, and the computer 6.

In each of the other mobile devices, the list-updating unit 19 updates the list in the list storage unit 18 on the basis of the received list information (step SB4). Thus, even for lists stored in the list storage units 18 of the portable music player 4, the PDA 5, and the computer 6, “File X1” is added to the music data list of the mobile phone 3 to form an updated list.

According to the mobile device system 1 as described above, not only the list of files and data stored in the information storage unit 15 of that mobile device, but also the lists of files and data stored in the information storage units 15 of the other mobile devices is stored in the list storage unit 18. Therefore, by displaying the lists stored in the list storage unit 18 on the display unit 13, even when the other mobile devices are turned off, it is possible to show the user the information which the other mobile devices hold. Thus, the user can also confirm the information which the other mobile devices hold without starting up the other mobile devices.

On the list displayed on the display unit 13 of the mobile device which the user has activated, when the user specifies the information stored in the information storage unit 15 of another mobile device, a transmission request for that information is sent to the other mobile device, and this information is sent back from the other mobile device which received this request and is displayed on the display unit 13 of the first mobile device. Therefore, the user can confirm the specified information as if it were stored in the information storage unit 15 of the mobile device which he or she is operating.

Even when the mobile device containing the specified information is powered off, by sending the activation signal to the other mobile device, it is possible to activate the other mobile device. Therefore, the desired information can be obtained and displayed on the display unit 13. Accordingly, the user can reliably confirm the desired information without operating the other mobile device.

With such a mobile device system, when the information stored in the information storage unit 15 of one mobile device is updated, this update information is also notified to the other mobile devices, and the lists in the list storage unit 18 of the other mobile devices are also updated. Therefore, the most recent list information can always be shared among the mobile devices. Accordingly, when operating any of the mobile devices, the user can confirm the desired data using the mobile device that he or she is operating.

In the embodiment described above, the user specifies the desired information by transitioning the screen displayed on the display unit 13 of the mobile phone 3 from that in FIG. 5 to that in FIG. 9. However, this screen transition is merely an example; the information may be specified by, for example, the screen transitions described below.

### First Modification

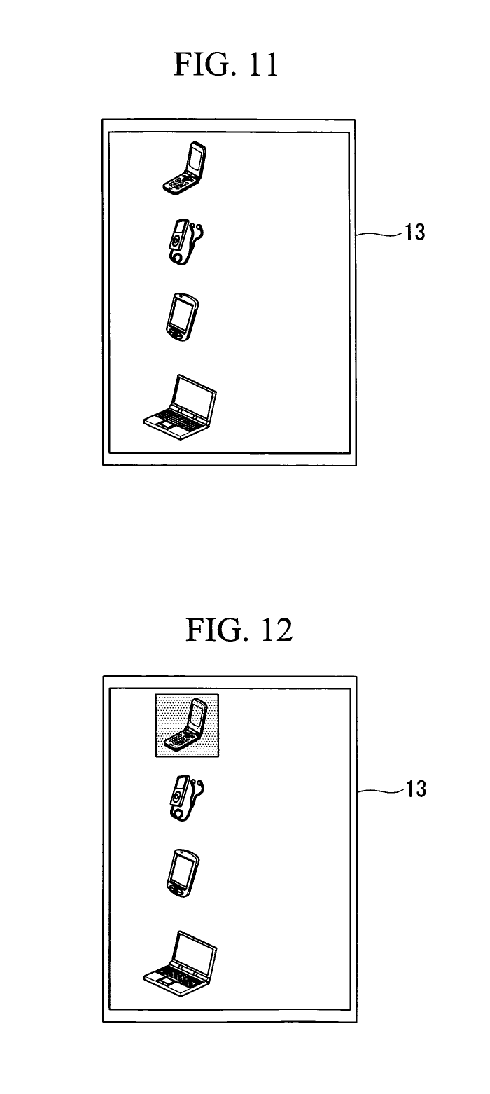

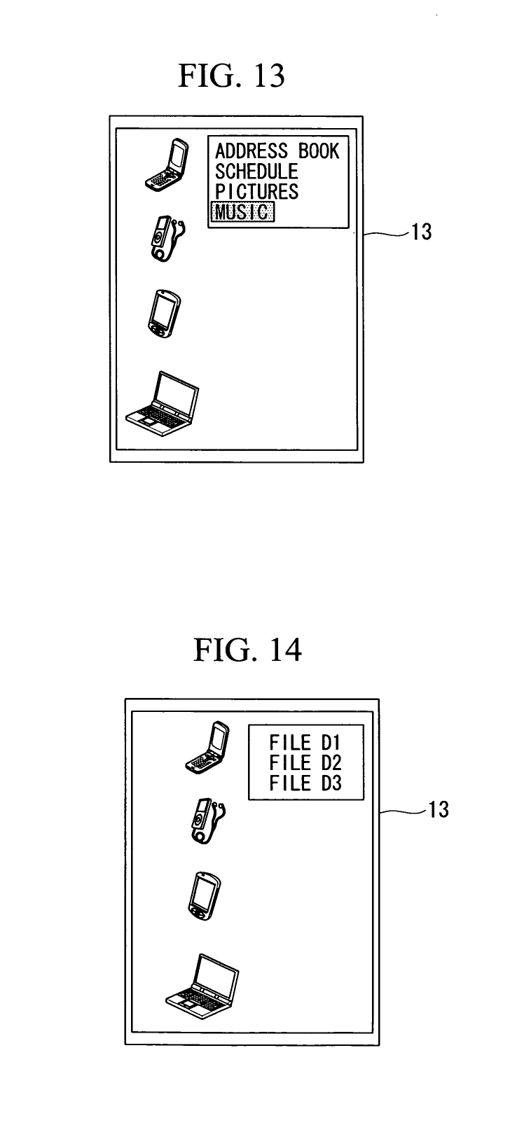

First, as shown in FIG. 11 for example, when icons for all of the mobile devices are displayed on the display unit 13 and one mobile device is specified by the user on this display screen, file types for the data stored in the information storage unit 15 of the specified mobile device are displayed. For example, as shown in FIG. 12, when the mobile phone 3 is specified on the display screen shown in FIG. 11, as shown in FIG. 3, the control unit 16 reads a list of file types of the mobile phone from the list storage unit 18 and displays the read file types as shown in FIG. 13. When one file type is specified by the user on this screen, for example, when the file type “music” is specified, the control unit 16 reads a list of music files or data stored in the information storage unit 15 of the mobile phone 3 by referring to the list in the list storage unit 18 and displays it on the display unit 13. Thus, as shown in FIG. 14, the list of music files stored in the information storage unit 15 of the mobile phone 3 is displayed. The user specifies the desired file or data on this screen.

### Second Modification

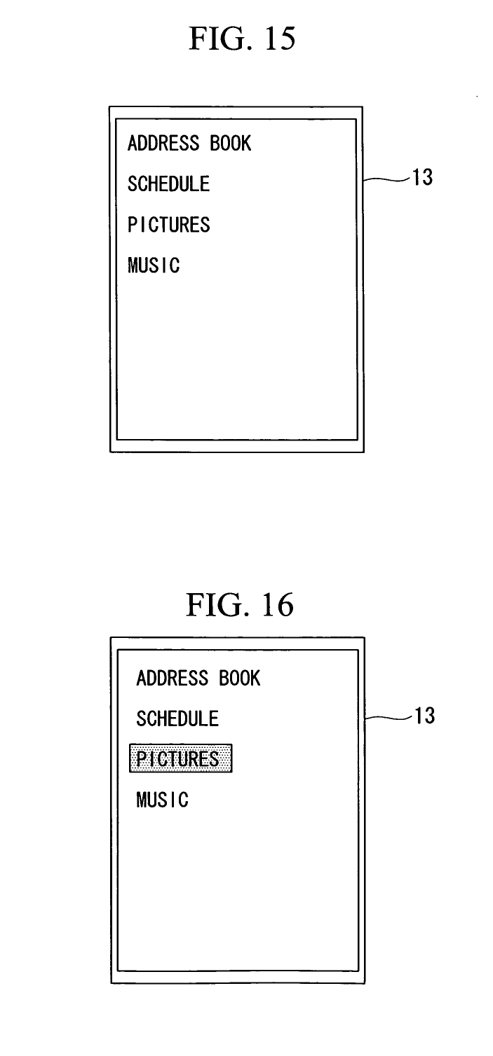

For example, as shown in FIG. 15, the control unit 16 first reads the file types from the list storage unit 18 and displays these file types on the display unit 13. When one file type, for example, “Pictures” as shown in FIG. 16, is specified on this display screen by the user, the control unit 16 identifies file information corresponding to the file type “Pictures” from the list shown in FIG. 3 and displays the identified file information on the display unit 13.

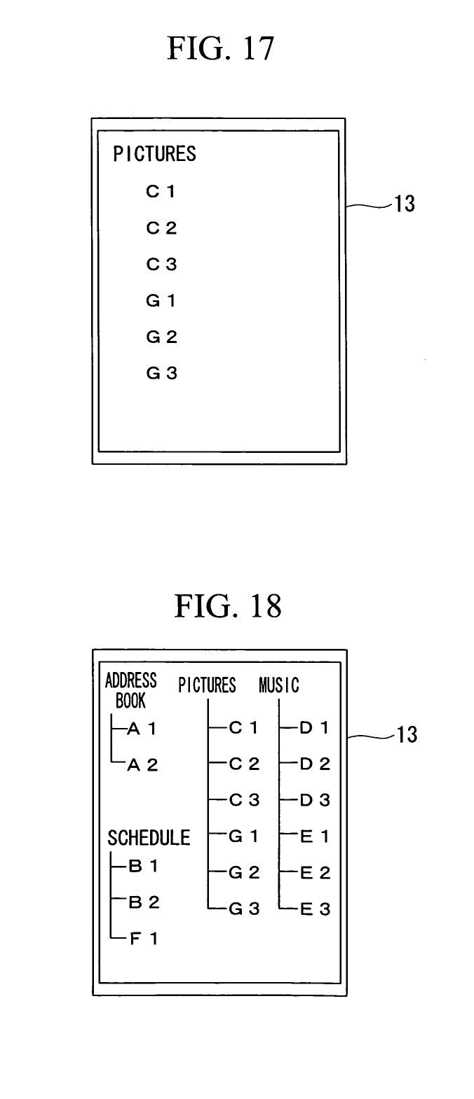

Here, as shown in FIG. 3, the file information corresponding to the file type “Pictures” is C1, C2, C3, G1, G2, and G3. Therefore, as shown in FIG. 17, the control unit 16 displays these file names on the display unit 13. The user then specifies the desired file or data on this screen.

With this modification, because only a list of file types is displayed on the display unit 13, in other words, because information showing which files are stored in which mobile device's information storage unit 15 is not displayed on the display unit 13, the user can easily specify the desired file without being aware of which mobile device's information storage unit 15 the desired information is stored in.

### Third Modification

For example, the control unit 16 reads file types and file information corresponding to those file types from the list storage unit 18, separates the read file information into each file type, and displays it on the display unit 13 (see FIG. 18).

Thus, according to this modification, the various files stored in the information storage unit 15 of each mobile device are classified by file type and displayed as a list, whereas information about which file information is stored in which mobile device's information storage unit 15 is not displayed at all. Therefore, the user can specify the desired file on this display screen without being aware of which mobile device's information storage unit 15 the desired file is stored in. In addition, with this modification, because the actual file names are displayed on the display unit 13, the user can directly specify the desired file on this initial screen.

Although an embodiment of the mobile device system and the mobile device have been described above with reference to the drawings, the specific configurations are not limited to this embodiment. The present invention encompasses various modifications so long as they do not depart from the spirit of the invention.

What is claimed is:

1. A mobile device system comprising:
a plurality of mobile devices,
wherein each mobile device includes a communication unit for communicating with other mobile devices, an information storage unit for storing information, a list storage unit for storing a list of information stored in the information storage unit and in the information storage units of the other mobile devices, a display unit, and a control unit,
wherein the control unit displays the list stored in the information storage unit on the display unit and, when information stored in the information storage unit of another mobile device is specified, requests transmission of information from the other mobile device using the communication unit and displays information transmitted in response to the request on the display unit.

2. A mobile device system according to claim 1, wherein the control unit of each mobile device obtains file types from the list storage unit and displays a list of the obtained file types on the display unit.

3. A mobile device system according to claim 1, wherein each of the control units extracts file types and file information from the list storage unit and displays the extracted file types and a list of each file information corresponding thereto on the display unit.

4. A mobile device system according to claim 1, wherein each of the mobile devices includes an activating unit for activating power in response to an activation signal from another mobile device, and
when the information specified on the list is stored in the information storage unit of another mobile device, the control unit of each mobile device controls the communication unit so as to send an activation signal to that other mobile device.

5. A mobile device system according to claim 1, wherein each of the mobile devices includes a list-updating unit for updating the list stored in the list storage unit when the information stored in the information storage unit is changed, or when update information is received from another mobile device, and
the control unit of each of the mobile devices controls the communication unit so as to send update information to the other mobile devices when the information stored in the information storage unit of that mobile device is changed.

6. A mobile device comprising:
a communication unit for communicating with other mobile devices;
an information storage unit for storing information;
a list storage unit for storing a list of information stored in the information storage unit and in the information storage units of the other mobile devices;
a display unit; and
a control unit,
wherein the control unit displays the list stored in the information storage unit on the display unit and, when information stored in the information storage unit of another mobile device is specified, requests transmission of the information from the other mobile device using the communication unit and displays information transmitted in response to that request on the display unit.
